(19) United States
(12) Patent Application Publication
(10) Pub. No.: US 2009/0257783 A1
(43) Pub. Date: Oct. 15, 2009

(54) IMAGE FORMING APPARATUS AND DEVELOPING DEVICE

(75) Inventors: Takashi HATAKEYAMA, Kanagawa-ken (JP); Hiroshi MURATA, Kanagawa-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/418,717

(22) Filed: Apr. 6, 2009

(30) Foreign Application Priority Data
Apr. 11, 2008 (JP) 2008-103166

(51) Int. Cl. G03G 15/08

(52) U.S. Cl. 399/256

(57) ABSTRACT

An image forming apparatus includes an image carrying member, an electrostatic latent image forming portion configured to form an electrostatic latent image on the image carrying member, and a developing device configured to develop the electrostatic latent image to form a developer image and the developing device is comprised a developer case to store a developer comprising toner and a carrier, a discharge spout provided on a wall surface in the developer case to overflow and discharge the developer increased excessively, a divider member configured to divide an inside of the developer case into a plurality of spaces, and a passing hole which is formed in the dividing member opposite to the discharge spout and is formed so as to permit the developer to pass through.

### CROSS-REFERENCE TO RELATED APPLICATION

This application is based upon and claims the benefit of priority from the prior Japanese Patent Application No. 2008-103166, filed on Apr. 11, 2008; the entire contents of all of which are incorporated herein by reference.

### FIELD OF THE INVENTION

The present invention relates to an image forming apparatus using a two-component developer composed of toner and a carrier and a developing device.

### DESCRIPTION OF THE BACKGROUND

In a dry type two-component developer composed of toner and a carrier, the toner is consumed by image formation, though the carrier remains in the developing device. And, regarding the carrier, the resin coat material on the carrier surfaces is separated and the toner component is adhered to the carrier surfaces, thus the charging capacity as a developer is lowered and the image quality is deteriorated.

Therefore, separately from supply of toner consumed by image formation, a system for supplying a carrier is proposed. Here, the toner is consumed by image formation, though the carrier remains in the developer case of the developing device. Therefore, if it is intended to keep the toner density of the developer constant, the developer quantity in the developer case is increased. Therefore, the developer increased excessively in the developer case may overflow and be discharged from the developer discharge spout for discharging the developer which is installed on the wall surface of the developer case.

The supply and discharge of the developer are repeated successively like this, thereby the deteriorated developer in the developer case is replaced with a developer newly supplied, thus the developer quantity is kept constant by keeping the characteristics of the developer satisfactory.

In Japanese Patent Application Publication No. 07-121017, in the developing device as described above, the developer quantity discharged by overflow is influenced greatly by the shape of the discharge spout for discharging the developer and the mechanism having a characteristic discharge spout shape is disclosed.

The discharge quantity of the developer discharged by overflow depends on the shape of the discharge spout, though it is greatly influenced by the physical properties of the developer. For example, in an environment of high temperature and high humidity, the physical properties of the developer are changed and the developer quantity in the developer case is increased extremely. The developer is discharged from the discharge spout, though at this time, the developer is accumulated on the upper end of the discharge dam forming the discharge spout. If the fluidity of the developer is lowered in the environment of high temperature and high humidity, the height of the developer accumulated on the upper end of the discharge dam is increased. By doing this, the practical height of the discharge dam is increased and the area of the discharge spout is reduced. Therefore, the discharge quantity of the developer is reduced and the developer quantity in the developer case is increased. Namely, even if the shape of the discharge spout is only changed, the developer is not discharged sufficiently.

### SUMMARY OF THE INVENTION

An object of the present invention is to provide an image forming apparatus and a developing device, even if the physical properties of the developer are changed due to change in the environment, for discharging stably the developer and reducing the change in the developer quantity in the developer case.

An image forming apparatus is provided in an embodiment of the present invention and the image forming apparatus comprises an image carrying member; an electrostatic latent image forming portion configured to form an electrostatic latent image on the image carrying member; and a developing device configured to develop the electrostatic latent image to form a developer image, wherein the developing device includes a developer case configured to store a developer comprising toner and a carrier; a discharge spout provided on a wall surface in the developer case to overflow and discharge the developer increased excessively; a divider member configured to divide an inside of the developer case into a plurality of spaces; and a passing hole formed in the divider member opposite to the discharge spout and formed so as to permit the developer to pass through.

Further, a developing device is provided in an embodiment of the present invention and the developing device comprises a developer case configured to store a developer comprising toner and a carrier; a discharge spout provided on a wall surface in the developer case to overflow and discharge the developer increased excessively; a divider member configured to divide an inside of the developer case into a plurality of spaces; and a passing hole provided in the divider member opposite to the discharge spout and formed so as to permit the developer to pass through.

### BRIEF DESCRIPTION OF THE DRAWINGS

FIG. 1 is an internal block diagram showing the image forming apparatus body which is an embodiment of the present invention;

FIG. 2 is an internal schematic view of the developing device viewed from above for explaining Embodiment 1;

FIG. 3 is a schematic view showing the developing device of Embodiment 1;

FIG. 4 is a cross sectional view of the developing device which is an embodiment of the present invention;

FIG. 5 is a schematic view of the image forming portion of the image forming apparatus which is an embodiment of the present invention;

FIG. 6 is a schematic view showing the developing device of Embodiment 2; and

FIG. 7 is a cross sectional view of the developing device viewed in the direction of the arrow B shown in FIG. 6.

### DETAILED DESCRIPTION OF THE INVENTION

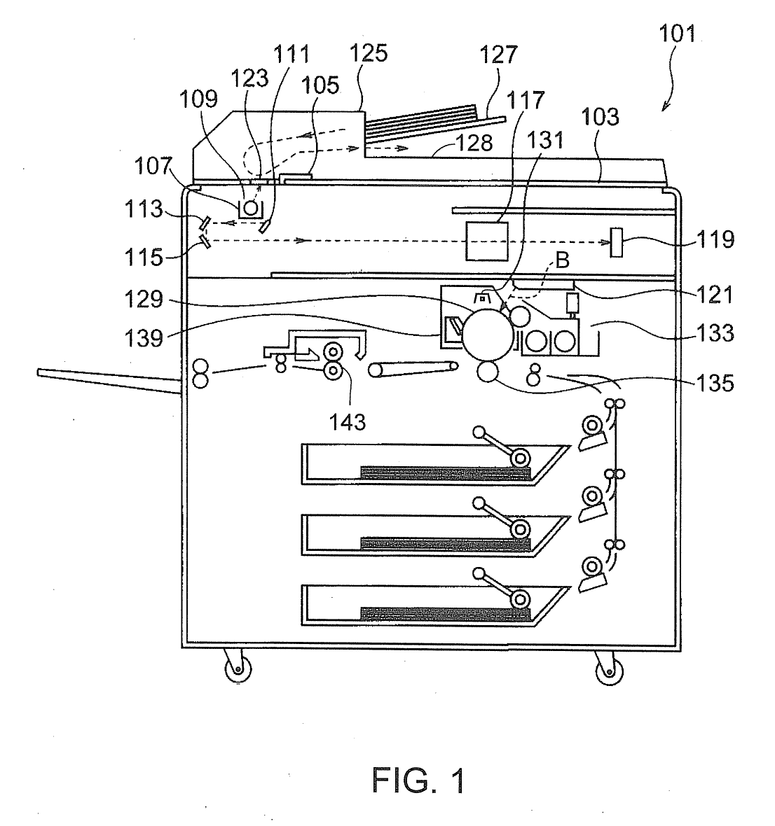

Hereinafter, the embodiments of the present invention will be explained with reference to the accompanying drawings.

[Embodiment 1] The entire constitution of an image forming apparatus 101 relating to this embodiment is shown in FIG. 1. On the upper part of the image forming apparatus 101, a transparent document table 103 for loading documents is installed. On one side of the document table 103, an indicator 105 is installed. The step part between the indicator 105 and the document table 103 is a reference position for setting documents. On the bottom side of the document table 103, a carriage 107 is installed and an exposure lamp is installed on the carriage 107. By the carriage 107 and exposure lamp 109, an exposure unit is formed. The carriage 107 moves along the bottom of the document table 103. The carriage 107 moves back and forth along the document table 103 and the exposure lamp 109 is turned on, thus a document loaded on the document table 103 is exposed.

By exposure to the document, a reflected light image from the document is obtained and the reflected light image is projected onto a CCD 119 by reflection mirrors 111, 113 and 115 and a lens block 117. The CCD 119 has many photoelectric conversion devices in the light receiving area. The CCD 119 line-scans the light receiving area and repeats the line scanning, thereby outputs an image signal corresponding to the document image. The image signal outputted from the CCD 119 is amplified and is converted to a digital signal. The digital signal is image-processed properly and is supplied to a laser unit 121 which is an exposure unit. The laser unit 121 emits a laser beam according to the input signal.

At the position neighboring with the indicator 105 of the document table 103, a window 123 for reading documents is installed. The window 123 has a dimension corresponding to the length of the indicator 105 in the longitudinal direction. Above the document table 103, indicator 105 and window 123, an automatic document feeder 125 serving as a cover of the document table 103 is installed in openable and closable. The automatic document feeder 125 has a supply tray 127 for loading documents. The automatic document feeder 125 feeds a plurality of documents set in the tray 127 one by one to the window 123 and discharges the documents passing through the window 123 onto a discharge tray 128. When the automatic document feeder 125 operates, the exposure lamp 109 emits light at the position corresponding to the window 123 and the light is irradiated to the window 123. The light irradiated to the window 123 exposes a document passing on the window 123 through the window 123. By this exposure, a reflected light image from the document is obtained and the reflected light image is projected onto the CCD 119 by the reflection mirrors 111, 113 and 115 and lens block 117.

On the other hand, almost at the central part in the body, a photosensitive drum 129 which is an image carrying member is installed rotatably. Around the photosensitive drum 129, a charger 131, a developing device 133, a transfer device 135 and a cleaner 139 are arranged sequentially. A developer image transferred onto a sheet by the transfer device 135 is fixed by a fixing device 143. A laser beam B emitted from the laser unit 121 is irradiated to the surface of the photosensitive drum 129 through the space between the charger 131 and the developing device 133.

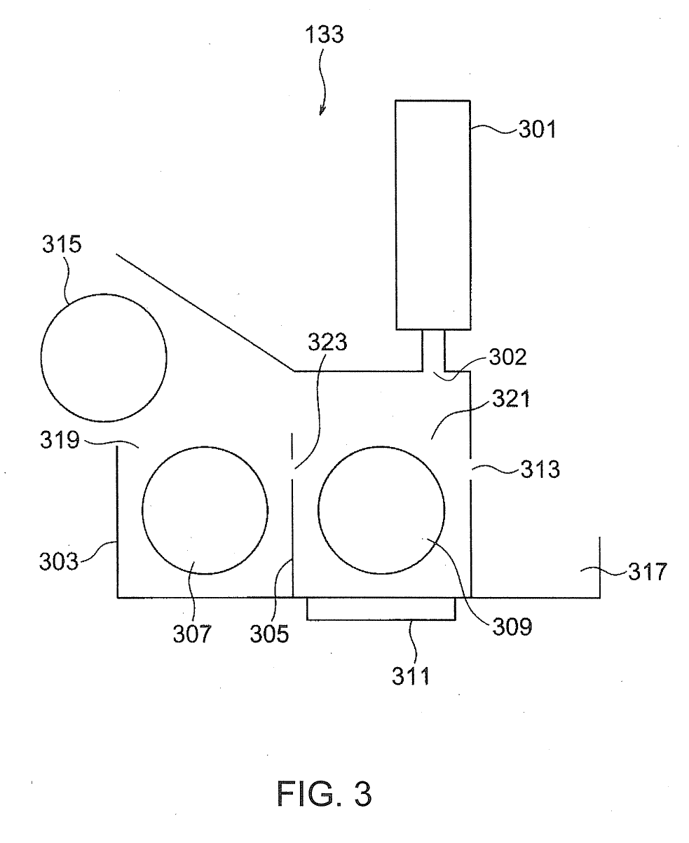

Next, the developing device 133 will be explained by referring to FIG. 3. The developing device 133 has a developer replenishing container 301 for storing toner and a carrier composing a two-component developer. Further, the developing device 133 has a developer case 303 and in the developer case 303, a developing roller 315 is installed rotatably. The developing roller 315 is arranged opposite to the photosensitive drum 129 and the toner and carrier are held on the surface of the developing roller 315 and the developing roller 315 is rotated, thus the toner held on the developing roller 315 is supplied onto the photosensitive drum 129.

The developer replenishing container 301 is mounted on the developer case 303, thus the toner and carrier are supplied to the developer case 303 through a replenishing port 302. The developer case 303 is separated into a first space 319 and a second space 321 by the divider plate 305 which is a divider member. From the developer replenishing container 301 mounted on the upper part of the second space 321, the toner and carrier are supplied into the developer case 303.

On the side of the developer case 303 on the side of the second space 321, a developer discharge spout 313 for discharging a surplus developer is installed. The first space 319 and second space 321 are interconnected to each other. The first space 319 and second space 321 have respectively a circulation mechanism so as to mutually circulate the developer. As a circulation mechanism, a first auger 307 is installed in the first space 319 and a second auger 309 is installed in the second space 321. The first auger 307 and second auger 309 are rotated, thus the developer in the developer case 303 is conveyed by being stirred. The developer of the developer case 303 is circulated in the conveying direction, in the example shown in FIG. 3, such as in the second space 321, in the direction from this side to the innermost side and in the first space 319, in the direction from the innermost side to this side.

In the second space 321, a toner density detector 311 for detecting the toner density of the developer stirred and conveyed by the second auger 309 is installed. If the toner density detected by the toner density detector 311 is reduced to a predetermined value or lower, a developer is replenished from the developer replenishing container 301. The toner is consumed by image formation, though the carrier remains in the developer case 303 of the developing device 133. Therefore, if it is intended to keep the toner density of the developer in the developer case 303 constant, due to supply of the developer, the developer quantity in the developer case 303 is increased. Therefore, the developer increased excessively overflows and is discharged from the developer discharge spout 313 installed on the wall surface of the developer case 303. The developer discharged due to overflow is accumulated in a receiving portion 317.

Next, the developer discharge spout 313 of this embodiment will be explained. With respect to the developer, in an environment of high temperature and high humidity (in this embodiment, for example, at a temperature of 30° C. and a humidity of 80%), the physical properties thereof are changed and the fluidity thereof gets worse. Therefore, the quantity of the developer discharged from the developer discharge spout 313 in an environment of normal temperature and normal humidity (in this embodiment, for example, at a temperature of 20° C. and a humidity of 50%) and the quantity of the developer discharged from the developer discharge spout 313 in an environment of high temperature and high humidity are different from each other. In the environment of high temperature and high humidity, the quantity of the developer discharged from the developer discharge spout 313 becomes smaller. Therefore, the position where the developer discharge spout 313 is installed in this embodiment is determined, under the condition that the developer in the environment of high temperature and high humidity is hardly discharged, so as to discharge the developer in a predetermined quantity. Further, the dimensions of the developer discharge spout 313, in this embodiment, are set at 30 mm in length and 5 mm in width in the longitudinal direction of the developer case 303.

Next, the divider plate 305 of this embodiment will be explained in detail. As described above, by the divider plate 305, the inside of the developer case 303 is divided into the first space 319 and the second space 321. The divider plate 305 has a passing hole 323 at the position opposite to the developer discharge spout 313.

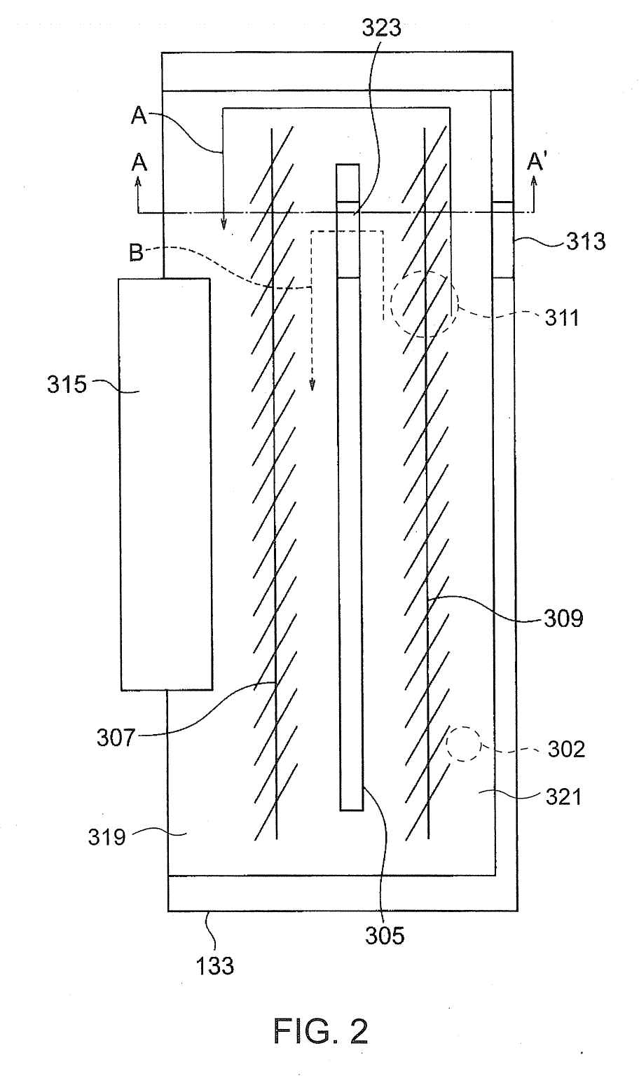

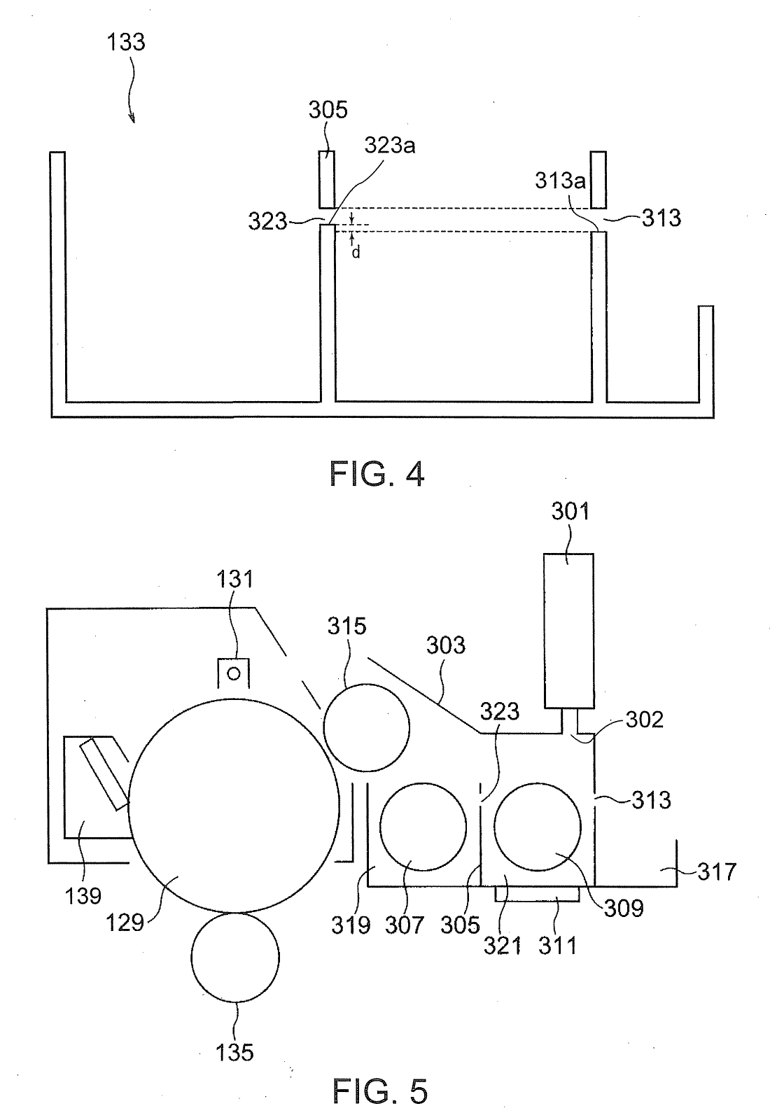

FIG. 4 is a cross sectional view of the developing device shown in FIG. 2 viewed in the direction of the arrow A-A′. In FIG. 4, the first auger 307 and second auger 309 are omitted. As shown in the drawing, in this embodiment, a lower edge 323a of the passing hole 323 is provided so as to be positioned above a lower edge 313a of the developer discharge spout 313 by d [mm]. However, the lower edge 323a of the passing hole 323 may be the same position as the lower edge 313a of developer discharge spout 313.

Next, the operation of each device during printing of the image forming apparatus 101 using the developing device of this embodiment will be explained. FIG. 5 is a schematic view of the image forming portion of the image forming apparatus 101 of this embodiment.

If an instruction of printing is input, the surface of the photosensitive drum 129 is charged by the charger 131. The charged photosensitive drum 129 is exposed according to a document image by the laser unit 121 and an electrostatic latent image is formed on the photosensitive drum 129. The electrostatic latent image on the photosensitive drum 129 is developed by toner on the developing roller 315 of the developing device 133 and a toner image is formed. To the developing roller 315, the developer is stirred and conveyed by the first auger 307 and second auger 309.

The toner image formed on the photosensitive drum 129 is transferred onto a sheet by the transfer device 135. The toner image transferred onto the sheet is fixed by the fixing device 143. The residual toner on the photosensitive drum 129 after the toner image is transferred onto the sheet is collected by the cleaner 139. The developer consumed by printing is replenished in the developer case 303 by the developer replenishing container 301. The carrier in the developer case 303 is increased by supply of the developer, though the developer is discharged from the developer discharge spout 313. The discharged developer is accumulated in the receiving portion 317.

The toner density in the developer case 303 is detected by the toner density detector 311 and the supply quantity of the developer is controlled.

Next, the flow of the developer in the developer case 303 of this embodiment will be explained by referring to FIG. 2. In the environment of normal temperature and normal humidity (25° C., 60%), the developer is conveyed fluidly. The developer conveyed in the neighborhood of the passing hole 323 passes through the passing hole 323 and is conveyed into the first space 319 (in the route of the arrow B).

In the developing device 133 of this embodiment, the developer discharge spout 313 is installed so as to discharge a predetermined quantity of developer in the environment of high temperature and high humidity, so that in the environment of normal temperature and normal humidity, the developer is discharged more than the predetermined quantity. However, the passing hole 323 is installed, so that the developer is discharged to the developer discharge spout 313 and is simultaneously distributed to the passing hole 323.

Therefore, in the environment of normal temperature and normal humidity, the developer will not be discharged excessively by the developer discharge spout 313. In the environment of high temperature and high humidity, the fluidity of the developer gets worse and the developer hardly passes through the passing hole 323, so that the developer flowing toward the developer discharge spout 313 is increased in quantity and the developer is discharged easily from the developer discharge spout 313.

Therefore, in the environment of normal temperature and normal humidity, the developer will not be discharged excessively by the developer discharge spout 313. In the environment of high temperature and high humidity, since the fluidity of the developer gets worse and the developer hardly passes through the passing hole 323, the developer is conveyed along with the arrow A rout shown in FIG. 2. Therefore, the developer flowing toward the developer discharge spout 313 is increased in quantity and the developer is discharged easily from the developer discharge spout 313.

As mentioned above, the passing hole 323 is formed in the divider plate 305, so that both in the environment of normal temperature and normal humidity and the environment of high temperature and high humidity, the developer can be discharged satisfactorily.

[Embodiment 2] In Embodiment 1 aforementioned, the passing hole 323 is formed in the divider plate 305 installed in the developer case 303. However, this embodiment uses a structure that the passing hole 323 is not formed in the divider plate 305 and a part of the divider plate 305 on the side that in the developer case 303, the developer is conveyed from the second space 321 to the first space 319 is lowered in height. The other constitution and operation are the same as those of Embodiment 1, so that to the same components, the same numerals are assigned and the explanation thereof is omitted.

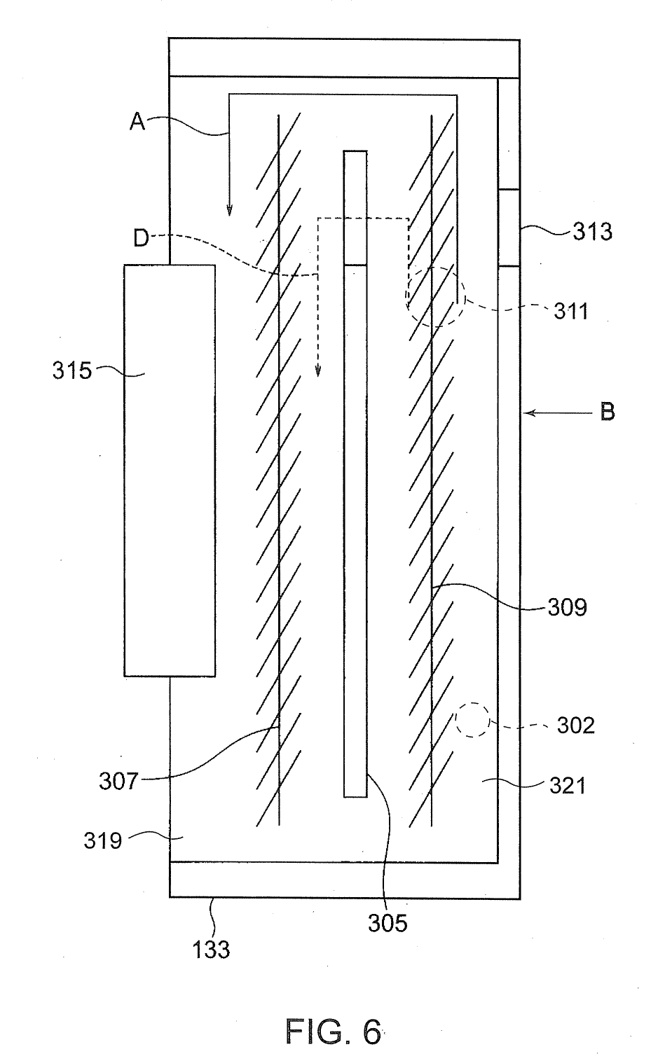

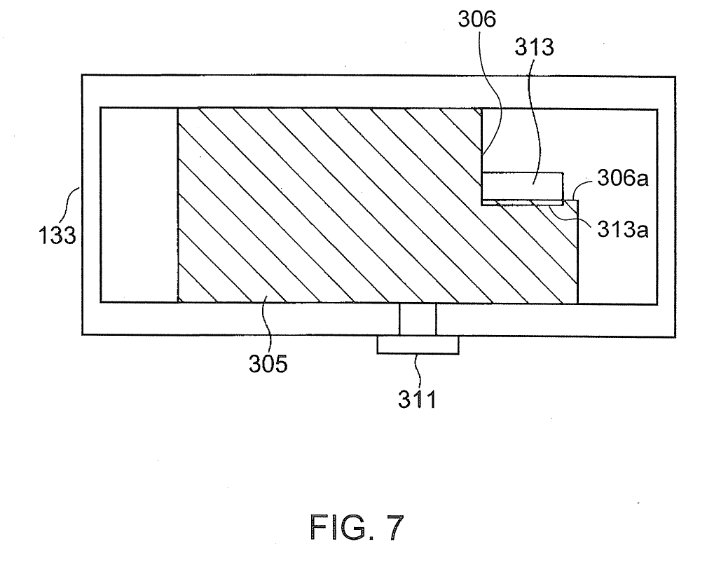

FIG. 6 is a schematic block diagram of the developing device of this embodiment viewed from above. FIG. 7 is a cross sectional view of the developing device viewed in the direction of the arrow B shown in FIG. 6. The hatched part shown in FIG. 7 indicates the divider plate 305 and a cutout portion 306 is formed at the leading edge of the divider plate 305. As shown in FIG. 7, the position of a lower edge 306a of the cutout portion 306 formed in the divider plate 305 of this embodiment is set at the position slightly higher than the position of the lower edge 313a of the developer discharge spout 313. However, the lower edge 306a of the cutout portion 306 may be the same position as the lower edge 313a of the developer discharge spout 313.

The flow of the developer in the developer case 303 of this embodiment will be explained by referring to FIG. 6. In the environment of normal temperature and normal humidity (25° C., 60%), the developer is conveyed fluidly. The developer conveyed in the neighborhood of the lower edge 306a of the cutout portion 306 formed in the divider plate 305 gets over and passes the lower edge 306a of the cutout portion 306 and is conveyed to the first space 319 (in the route of the arrow D). In the developing device 133 of this embodiment, the developer discharge spout 313 is installed so as to discharge a predetermined quantity of developer in the environment of high temperature and high humidity, so that in the environment of normal temperature and normal humidity, the developer is discharged more than the predetermined quantity. However, the cutout portion 306 is installed in the divider plate 305, so that the developer is discharged to the developer discharge spout 313 and is simultaneously distributed to the route D.

Therefore, in the environment of normal temperature and normal humidity, the developer will not be discharged excessively by the developer discharge spout 313. In the environment of high temperature and high humidity, the fluidity of the developer gets worse. In this state, since the developer does not pass through the route D, the developer is conveyed along with the arrow A shown in FIG. 6. Therefore, the developer flowing toward the developer discharge spout 313 is increased in quantity and the developer is discharged easily from the developer discharge spout 313.

Using the image forming apparatus 101 having the developing device 133 of the Embodiments 1 and 2, the lift test was conducted on 10000 sheets. Under the test condition that the developer quantity in the developer case 303 is 400 g and the test environments are the environment of normal temperature and normal humidity (25° C., 60%) and the environment of high temperature and high humidity (30° C., 80%), 10000 A4-sized sheets were printed at a print rate of 30%. As a result, as printed images, under both conditions of normal temperature and normal humidity and high temperature and high humidity, satisfactory images are obtained free of uneven density. The quantity of the developer in the developer case 303, in both Embodiments 1 and 2, is about 410 g in the environment of normal temperature and normal humidity and about 430 g in the environment of high temperature and high humidity. In the environment of high temperature and high humidity, the increase rate of the developer is about 8%, though it is within the tolerance and image formation provides no problem.

For comparison, in the developing device 133 of Embodiment 1, the passing hole 323 is closed and the similar test is conducted. As a result, as printed image quality, in the environment of normal temperature and normal humidity, satisfactory images are obtained free of uneven density, though in the environment of high temperature and high humidity, uneven density appears and no satisfactory images are obtained. Further, in the neighborhood of the developing roller 315, a leak of the developer is observed.

The quantity of the developer in the developer case 303, in the environment of normal temperature and normal humidity, is about 410 g, though in the environment of high temperature and high humidity, it is about 530 g including the leaked developer and the increased quantity of the developer is more than 30%. By the aforementioned test, the validity of the developing device 133 of the Embodiments 1 and 2 can be confirmed.

What is claimed is:

1. An image forming apparatus comprising:
an image carrying member;
an electrostatic latent image forming portion configured to form an electrostatic latent image on the image carrying member; and
a developing device configured to develop the electrostatic latent image to form a developer image,
wherein the developing device includes:
a developer case configured to store a developer comprising toner and a carrier;
a discharge spout provided on a wall surface in the developer case to overflow and discharge the developer increased excessively;
a divider member configured to divide an inside of the developer case into a plurality of spaces; and
a passing hole formed in the divider member opposite to the discharge spout and formed so as to permit the developer to pass through.

2. The apparatus according to claim 1, wherein the discharge spout and the passing hole have a rectangular shape.

3. The apparatus according to claim 2, wherein a position of a lower edge of the passing hole is the same as that of a lower edge of the discharge spout, or higher than the position of the lower edge of the discharge spout.

4. The apparatus according to claim 1 further comprising:
an auger provided so that the developer is stirred and conveyed in the plurality of spaces divided by the divider member.

5. The apparatus according to claim 4, wherein the auger includes a first auger configured to convey the developer in a first direction and a second auger configured to convey the developer conveyed in the first direction in a second direction opposite to the first direction.

6. The apparatus according to claim 4 further comprising:
a toner density detector provided so as to detect toner density of the developer conveyed.

7. The apparatus according to claim 6 further comprising:
a developer replenishing container provided so as to replenish a new developer into the developer case when the toner density detected by the toner density detector reduces to a predetermined value or lower.

8. The apparatus according to claim 1 further comprising:
a receiving portion provided so as to receive the developer discharged from the discharge spout by the overflow.

9. An image forming apparatus comprising:
an image carrying member;
an electrostatic latent image forming portion configured to form an electrostatic latent image on the image carrying member; and
a developing device configured to develop the electrostatic latent image to form a developer image,
wherein the developing device includes:
a developer case configured to store a developer comprising toner and a carrier;
a discharge spout provided on a wall surface in the developer case to overflow and discharge the developer increased excessively; and
a divider member provided so as to divide an inside of the developer case into a plurality of spaces, form a cutout portion that a position opposite to the discharge spout is lower than the other portions, and permit the developer to pass through the cutout portion.

10. The apparatus according to claim 9, wherein a position of a lower edge of the cutout portion is the same as that of a lower edge of the discharge spout, or higher than the position of the lower edge of the discharge spout.

11. The apparatus according to claim 9 further comprising:
an auger installed so that the developer is stirred and conveyed in the plurality of spaces divided by the divider member.

12. The apparatus according to claim 11, wherein the auger includes a first auger configured to convey the developer in a first direction and a second auger configured to convey the developer conveyed in the first direction in a second direction opposite to the first direction.

13. The apparatus according to claim 11 further comprising:
a toner density detector provided so as to detect toner density of the developer conveyed.

14. The apparatus according to claim 13 further comprising:
a developer replenishing container provided so as to replenish a new developer into the developer case when the toner density detected by the toner density detector reduces to a predetermined value or lower.

15. The apparatus according to claim 9 further comprising:
a receiving portion configured so as to receive the developer discharged from the discharge spout by the overflow.

16. A developing device comprising:
a developer case configured to store a developer comprising toner and a carrier;
a discharge spout provided on a wall surface in the developer case to overflow and discharge the developer increased excessively;
a divider member configured to divide an inside of the developer case into a plurality of spaces; and
a passing hole provided in the divider member opposite to the discharge spout and formed so as to permit the developer to pass through.

17. The device according to claim 16, wherein the discharge spout and the passing hole have a rectangular shape.

18. The apparatus according to claim 17, wherein a position of a lower edge of the passing hole is the same as that of a lower edge of the discharge spout, or higher than the position of the lower edge of the discharge spout.

19. A developing device comprising:
a developer case configured to store a developer comprising toner and a carrier;
a discharge spout provided on a wall surface in the developer case to overflow and discharge the developer increased excessively; and
a divider member provided so as to divide an inside of the developer case into a plurality of spaces, form a cutout portion that a position opposite to the discharge spout is lower than the other portions, and permit the developer to pass through the cutout portion.

20. The apparatus according to claim 19, wherein a position of a lower edge of the cutout portion is the same as that of a lower edge of the discharge spout, or higher than the position of the lower edge of the discharge spout.
